(19) United States
(12) Patent Application Publication
(10) Pub. No.: US 2010/0315236 A1
(43) Pub. Date: Dec. 16, 2010

(54) USER ACTIVATED ALARM FOR COMMUNICATION DEVICES

(76) Inventor: Anupam SAKARGAYAN, Nagpur (IN)

Correspondence Address: QUALCOMM INCORPORATED, 5775 MOREHOUSE DR., SAN DIEGO, CA, 92121, US

(21) Appl. No.: 12/482,205

(22) Filed: Jun. 10, 2009

(51) Int. Cl. G08B 13/14; H04W 4/00

(52) U.S. Cl. 340/571; 455/466

(57) ABSTRACT

Methods and devices for locating lost or stolen mobile devices allow users to remotely activate an alarm by receiving a secret number within a message directed to the mobile device, such as an SMS, MMS or e-mail message. Upon receiving a message containing a number, the mobile device determines whether the received number matches a secret number that is stored in secure memory. If the receive number matches the secret number in secure memory the mobile device activates an alarm mode. The alarm mode may include sounding an audible alarm to attract attention to the mobile device as well as other actions. The alarm mode may be deactivated by entering the secret number into the mobile device or by sending the secret number to the mobile device in a subsequent message.

### FIELD OF THE INVENTION

The present invention relates generally to cellular telephone technologies, and more particularly to protecting cellular phones from unauthorized use by providing an alarm system.

### BACKGROUND

Recent technological developments have made wireless digital communication increasingly commonplace. In addition to the ubiquitous cellular telephone, other personal mobile devices conduct digital communications with a variety of wireless networks. Being so common, when a mobile device is lost or stolen, an unauthorized user can use the mobile device without the fear of being identified or apprehended. A method for locating and identifying a lost or stolen mobile device may be useful to deter future theft of mobile devices and to encourage finders of lost mobile devices to return the devices to their rightful owners.

### SUMMARY

A method for remotely activating an alarm on a lost or stolen mobile device is disclosed. In the various embodiments, a secret number may be stored in a mobile device within a secure memory that is not accessible by users or applications. The mobile device may be configured to scan incoming messages, such as simple message service (SMS) messages, to determine if they contain the secret number. If so, the mobile device may sound an audible alarm which continues until the secret number is entered into the mobile device or sent in a subsequent message. Thereafter, if the mobile device is lost or stolen the owner can send an SMS or other type of message to the mobile device including the secret number to activate the alarm. A loud alarm may enable the user to locate the mobile device if lost and will deter others from using the mobile device since they are unable to deactivate the alarm.

In an embodiment, the mobile device may be configured to activate an alarm mode if it receives the secret number through an SMS or other type of message. Upon receipt of an SMS message, the mobile device parses the message payload to determine if the message body includes the secret number. The mobile device may then compare the secret number in the SMS payload to the secret number stored in the secure memory. If the two numbers match, the alarm mode may be activated and an alarm mode flag may be set in the secure memory indicating that the alarm mode has been activated. In the alarm mode the mobile device may sound an audible alarm by recalling a ringtone from memory and playing the ringtone at a high volume. The mobile device may also disable at least a part of the mobile device functionality. The alarm mode may be deactivated and the alarm mode flag reset when the mobile device receives the secret number in a keypad entry or in the body of a subsequent message.

An embodiment enables a user to change the secret number, such as by activating a menu option, and entering the secret number in response to a prompt by the mobile device. If the secret number entered by the user matches the current secret number stored in the secure memory, the mobile device may allow the user to enter a new secret number which is then stored in the secure memory.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a process flow diagram of an embodiment method for creating a secret number for a mobile device.

FIG. 2 is a process flow diagram of an embodiment method for activating an alarm mode by sending the secret number in an SMS message.

FIG. 3 is a process flow diagram of an embodiment method for deactivating an alarm mode.

FIG. 4 is a process flow diagram of an embodiment method for deactivating an alarm mode by sending an SMS message.

FIG. 5 is a process flow diagram of an embodiment method for changing the secret number.

FIG. 6 is a process flow diagram of an embodiment method for configuring alarm mode settings.

FIG. 7 is a system block diagram of a mobile device suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the terms “mobile device” and “handheld device” refer to any one or all of wireless gaming controllers, cellular telephones, personal data assistants (PDA's), palm-top computers, wireless electronic mail receivers (e.g., the Blackberry® and Treo® devices), multimedia Internet enabled cellular telephones (e.g., the Blackberry Storm®), Global Positioning System (GPS) receivers and similar personal electronic devices which include a programmable processor and memory.

To help locate lost mobile devices or to deter thieves of mobile devices, the various embodiments provide an alarm mode for mobile devices that users can activate remotely by sending a message containing a secret number. For ease of description, the term “secret number” is used herein to refer to a secret code or number known to an owner or authorized user of a mobile device which the user can transmit to or enter into a mobile device as part of the various embodiments. The secret number may be any code or number selected by users and need not identify a person or device. The secret number need not be a number per se, and may be a series of letters, a series of digits, a series of punctuation characters, or any combination of all three. Further, the code or number need not be a complete secret, as it may be known to a trusted number of people and institutions provided it is not generally accessible to the public as that would defeat the deterrence value of the code. Thus, the term secret number is not intended to limit the various embodiments to numbers, any particular form of code, nor an identifier assigned to the mobile device by a manufacturer, such as a serial number or MAC ID.

In overview, the various embodiments provide methods and devices for locating a lost or identifying a stolen a mobile device by allowing an authorized user to remotely activate a mobile device alarm system by transmitting a secret number to the mobile device. In a preferred embodiment, the user can activate the mobile device alarm by sending an SMS message, including a secret number, to the lost or stolen mobile device. The mobile device may be configured to parse the SMS message to determine whether a number that could be a secret number is included in the SMS payload. If so, the mobile device parses the message body (i.e., the portion of the message excluding addresses and status or importance flags) or message payload to obtain the number and compares it to the secret number stored in the mobile device's secure memory. If the received number and the stored secret number match, the mobile device activates the alarm mode. As part of setting the alarm mode, the mobile device may set an alarm mode flag in the secure memory. The alarm mode may be configured to produce a detectable (e.g. audible and visual) output. The output may be selected by a user, such as by designating a particular ringtone to be sounded when the alarm mode is activated. For example, a user could select an alarm ringtone so that when the alarm mode is activated the mobile device plays a very load siren or wavering tone, like a car alarm, to attract attention to the mobile device's thief. The alarm mode may be deactivated when the mobile device receives a correct secret number as a keypad entry or in the body of a subsequent message. As part of deactivating the alarm mode the alarm mode flag may reset. The alarm mode flag (or similar mechanism) ensures that the mobile device remains in the alarm mode until the correct secret number is entered even if the mobile device is turned off or the battery removed. Further security mechanisms may also be implemented such as deactivating part of the functionality or erasing portions of the memory, such as personal data files.

Wide spread use of such mobile device alarms may help deter the theft of mobile devices since thieves risk being found out and caught when the mobile device sounds the alarm. The audible alarm may also help users find lost mobile devices. Additionally or alternatively, an alarm mode that partially or wholly disables the mobile device's functionality and/or erases personal data may help to further deter the theft of mobile devices.

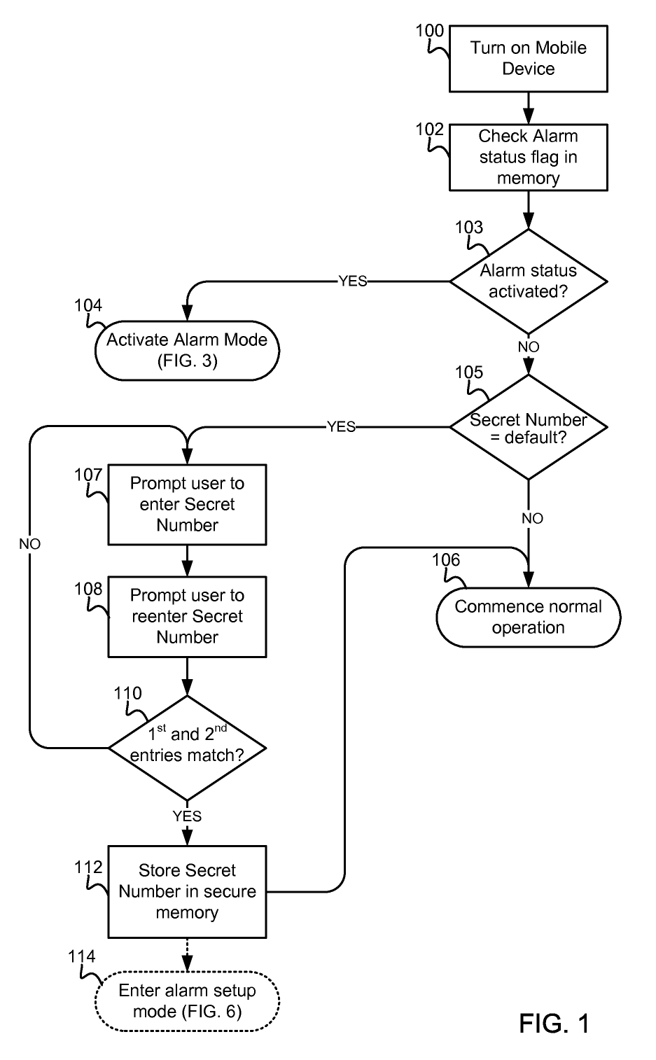

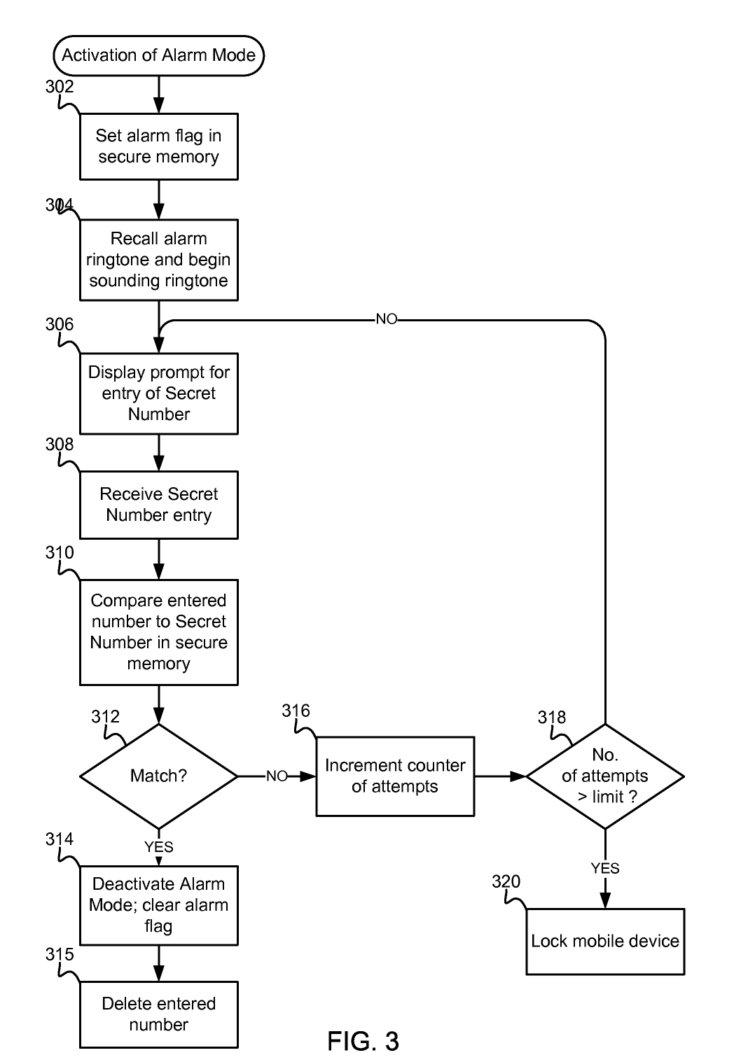

FIG. 1 is a process flow diagram of an example embodiment method for receiving and storing a secret number created by a user as may be implemented upon activation of a new mobile device. When a mobile device is turned on, step 100, the mobile device processor may be configured by software instructions to check an alarm status flag in the secure memory, step 102, to determine whether the alarm mode status is activated, determination 103. If the processor determines that the alarm mode is activated (i.e., determination 103=“YES”), the mobile device activates the alarm mode, step 4. Checking the alarm mode flag as part of a mobile device boot-up process will ensure that a mobile device alarm mode cannot deactivated by simply turning off the mobile device. The alarm mode flag is just one example way that the mobile device can be configured to remember that the alarm mode is activated when the device is turned off. The alarm mode activation process is described below in more detail with reference to FIG. 3.

If the mobile device determines that the alarm status is not activated (i.e., determination 103=“NO”), the mobile device may access the secret number stored in a secure memory of the mobile device to determine whether there is a stored number or if the stored secret number is a default number, determination 105. If the secure memory includes a stored number that is not a default number (i.e., determination 105=“NO”), this indicates that the mobile device has already been configured so the mobile device may commence normal operations, step 106.

Mobile devices may be configured by the manufacturer or distributor with no secret number or a default secret number, such as a string of zeros. When a user purchases a new mobile device from a manufacturer, distributor or service provider, the user may be required to enter a new secret number into the mobile device. For example, when a user purchases a new mobile device, as part of the mobile device set-up, the salesperson or service technician may require the user to create a secret number as part of configuring the device for use. As another example, the mobile device may be configured to detect when a secret number has not been created and to prompt the user to enter a new secret number before beginning normal operations. For example, the mobile device may be configured by the OEM with no or a default secret number, such as “00000” or “01234” which may be provided to the user in the user manual, for example.

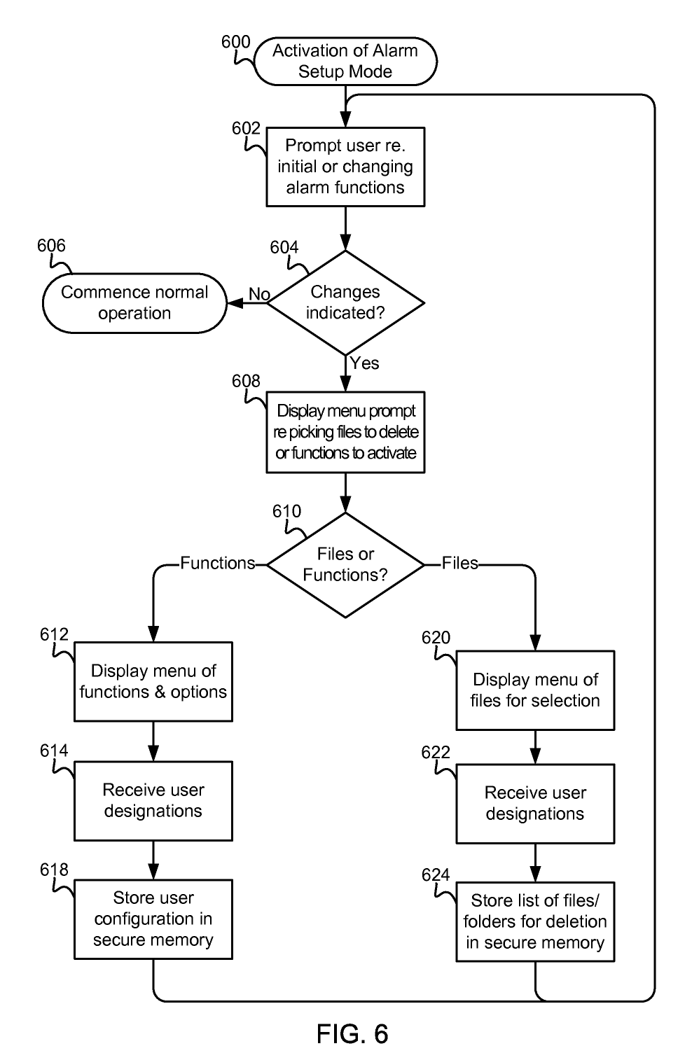

Upon activation, the mobile device may check the secret number stored in secure memory to determine if there is no secret number or if the stored secret number is the default, determination 103. If there is no secret number or the default secret number is stored in secure memory, (i.e., determination 105=“YES”), the mobile device may prompt the user to enter a new secret number, step 107. Upon receiving the new secret number, the mobile device may prompt the user to re-enter the same secret number, step 108. The mobile device then determines whether the two entries match, determination 110. Requiring double entry of the secret number helps to ensure that the new secret number is correctly entered before it is store in the secure memory. If the first and second entries match (i.e., determination 110=“YES”), the mobile device stores the new secret number in a secure memory, step 112. The secure memory is nonvolatile memory within the mobile device, such as within the processor or a memory chip that cannot be easily removed, which is not accessible by users or applications. If the first and second entries don't match (i.e., determination 110=“NO”), the mobile device prompts the user to repeat the double secret number entry process until both numbers match. Once the new secret number is stored in the secure memory, step 112, the mobile device may commence normal operations, step 106, or, optionally, enter an alarm setup mode to allow the user to configure actions that the mobile device should execute when the alarm mode is activated, optional step 114. Operations associated with the optional alarm setup mode are described below with reference to FIG. 6.

In an embodiment, the alarm mode of a mobile device may be activated when a user sends it an SMS including the secret number. SMS messages are transmitted wirelessly via the cellular telephone network. The SMS message is completely asynchronous and does not require an open communication link, IP address or other continuous communication infrastructure as is the case with standard wireless data networks. SMS messages will be rebroadcast for a number of days until delivery is finally achieved, thereby providing a reliable mechanism for communicating with a lost or stolen mobile device. However, other types of messages receivable by modern cellular telephones may be used besides SMS messages, including, for example, electronic mail, multimedia messaging service, and cellular data communications, such as Internet protocol messages.

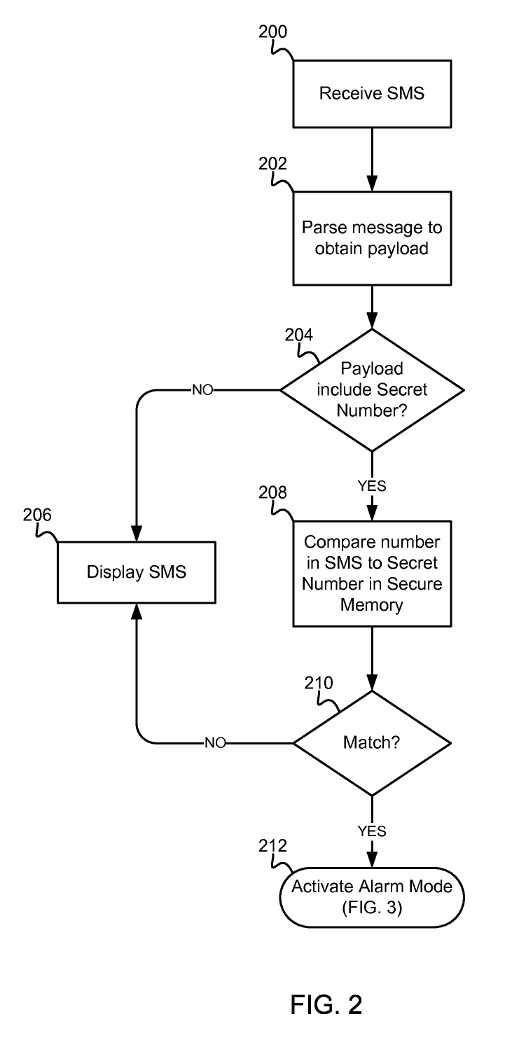

FIG. 2 illustrates an example method for remotely activating a mobile device alarm mode by sending the mobile device an SMS message including the secret number. When the mobile device receives an SMS message, step 200, its processor may parse the message into its constituent parts to obtain the payload, step 202. The mobile device processor may examine the message payload to determine whether it includes a number or code which could be a secret number, determination 204. In an example embodiment, secret numbers may be specified to contain a certain number of digits that are uncommon in most messages, such as 6, 9 or 12 to avoid confusion with zip codes and phone numbers. In another example, secret numbers may be specified to include a string of both letters and numbers which are uncommon in most messages. If the payload does not include a number or code which could be a secret number (i.e., determination 204=“NO”), the mobile device may simply display the SMS in the ordinary manner, step 206.

If the payload includes a number which could be a secret number (i.e., determination 204=“YES”), the mobile device processor may be configured by software instructions to compare the number in the SMS message payload to the secret number stored in the secure memory, step 208, to determine if the numbers match, determination 210. For example, the processor may subtract the number from the message from the secret number stored in the secure memory and test whether the remainder equals zero. If the number in the SMS message does not match the secret number stored in the secure memory (i.e., determination 210=“NO”), this indicates that the message is not an alarm activation message, so the mobile device may display the SMS message to the user in the ordinary manner, step 206. However, if the number in the SMS message matches the secret number stored in the secure memory (i.e., determination 210=“YES”), the processor may activate the alarm mode, step 212.

An example alarm mode activation process is illustrated in FIG. 3. When the alarm mode is activated, step 212 in FIG. 2, the mobile device processor may set an alarm mode flag in the secure memory, step 302. As noted above, setting an alarm mode flag in secure memory is one mechanism that can be used for ensuring the alarm mode remains active even when the mobile device is turned off or the battery is removed. Also, the processor may be configured to recall a pre-set alarm ringtone or audio file from memory and begin sounding the ringtone at a loud volume setting, step 304. In an embodiment, the alarm mode may be a user configurable feature, such as described below with reference to FIG. 6. For example, a menu may allow the user to select and designate a particular ringtone to be used in the alarm mode in a manner similar to how other alert ringtones can be set. This allows the user to designate the particular sound to be used. For example, some users may want a loud car alarm type audible alarm to sound if they anticipate their mobile device may be stolen, while other users may want a less obtrusive alarm to sound if they anticipate using the mode to locate a misplaced mobile device. In an optional embodiment, the alarm mode may include implementation of functions which lock or partially deactivate the mobile device (not shown in FIG. 3).

As part of the alarm activation process the mobile device may generate a display that prompts the user to enter the secret number into the keypad to deactivate the alarm, step 306. Entry of the correct secret number allows the user to deactivate the alarm such as when a lost mobile device is located. When a number entry is received by the mobile device, step 308, the processor may compare the entered number with the secret number stored in the secure memory, step 310, to determine whether the two numbers match, determination 312. If the processor determines that the two numbers match (i.e., determination 318=“YES”), it may deactivate the alarm mode, by clearing the alarm mode flag in the secure memory, terminating the ringtone, and resuming normal function, step 314. Additionally, in order to ensure the secret number is not disclosed, the number entered into the mobile device may be deleted from cache storage and from the display, step 315. However, if processor determines that the two numbers don't match (i.e., determination 318=“NO”), the mobile device may increment a counter of number entry attempts, step 316, and compare the counter to a limit to determine whether the number of entry attempts has exceeded a limit, determination 318. If the number of attempts to enter a correct secret number is less than the limit (i.e., determination 318=“NO”), the processor may prompt the user to reenter the secret number and follow the processes described above for steps 306 to 312. However, if the number of secret number entry attempts exceed the limit (i.e., determination 318=“YES”), the processor may be locked in some manner to prevent further use, step 320.

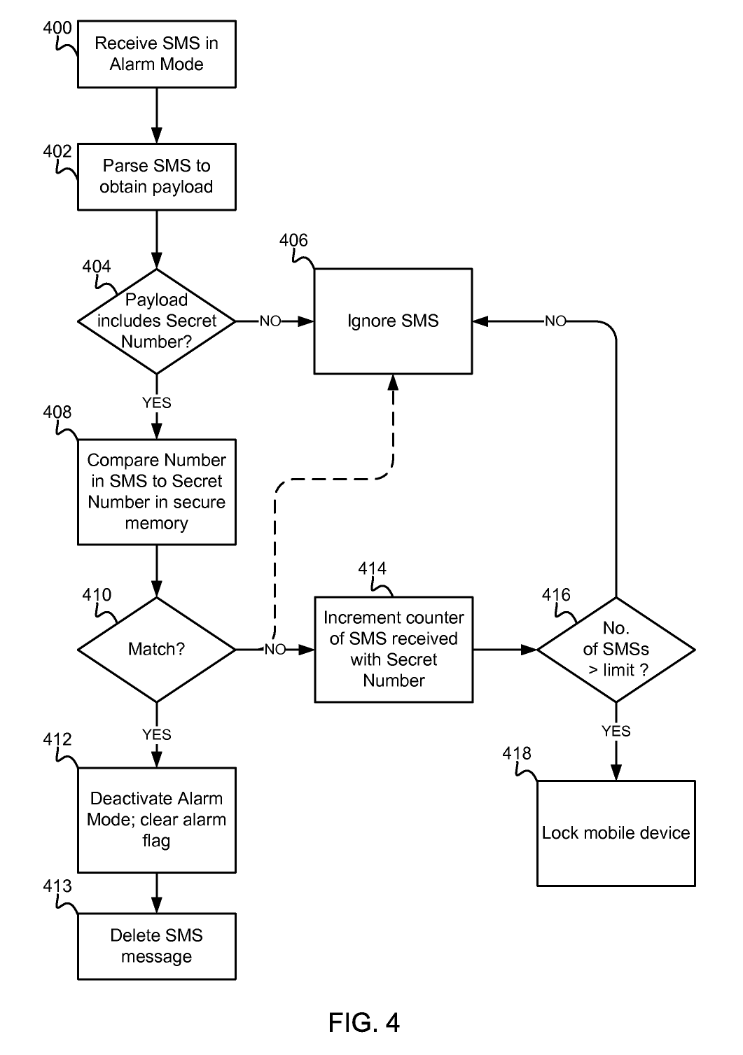

In an embodiment, the alarm mode may also be deactivated remotely by transmitting an SMS message to the mobile device that includes the secret number in the message payload. FIG. 4 illustrates an example method for implementing this embodiment. When an SMS message is received while the alarm mode is activated, step 400, the mobile device processor may parse the SMS message to obtain the message payload, step 402, and determine whether the payload includes a number that could be the secret number, determination 404. Example tests that may be used in this determination are described above with reference to FIG. 2, step 204. If the processor determines that the SMS payload does not include a secret number (i.e., determination 404=“NO”), the processor may simply ignore the SMS message since the alarm mode is activated, step 406. If the processor determines that the SMS payload includes a number which could be the secret number (i.e., determination 404=“YES”), the processor may compare the number in the SMS payload to the secret number stored in the secure memory, step 408, to determine whether the two numbers match, determination 410. If the processor determines that the two numbers match (i.e., determination 410=“YES”), the processor may deactivate the alarm mode, such as by clearing the alarm mode flag in the secure memory, terminating the ringtone, and resuming normal function, step 412. Additionally, to ensure the deactivation process does not reveal the secret number the SMS message conveying the secret number may be deleted from cache memory and from the list of received SMS messages, step 413.

If the processor determines that the two numbers do not match (i.e., determination 410=“NO”), the processor may increment a counter of SMSs received with an incorrect secret number, step 414, and determine whether the count of received of SMSs exceeds a limit, determination 416. If the processor determines that count of SMS received does not exceed the limit (i.e., determination 416=“NO”), the processor may ignore the SMS, step 406. However, if the processor determines that the number of received SMS messages containing incorrect secret numbers exceeds the limit (i.e., determination 416=“YES”), the processor may initiate further actions such as locking the mobile device in a manner that precludes further use, step 418. Optionally, when the processor determines that the number in the SMS payload does not match the secret number stored in the secure memory, the processor may simply ignore the SMS message, step 406. In this embodiment, there will be no limit imposed on the number of SMS messages containing secret number attempts that can be received by the mobile device.

The foregoing description of the secret number being conveyed within the body or payload of an SMS message (i.e., the portion of the message that excludes addresses, message delivery information, status flags, importance flags, etc.) is merely one embodiment that is provided for illustrative purposes only and is not intended to limit the scope of the claims to SMS messages or message payloads. In other embodiments, the secret number can be conveyed in any form of message that can be delivered to a mobile device, including MMS, e-mail, and an established Internet protocol communication link if available. Further, the secret number can be conveyed in any portion of such messages, including the message subject line, the message body or payload, and a message attachment, as well as metadata associated with the message. Processing methods for receiving the secret number in other types of messages and within other parts of messages would be substantially similar to those described above with reference to FIG. 4, differing only in the type of message received and the parsing process used to extract the proffered secret number.

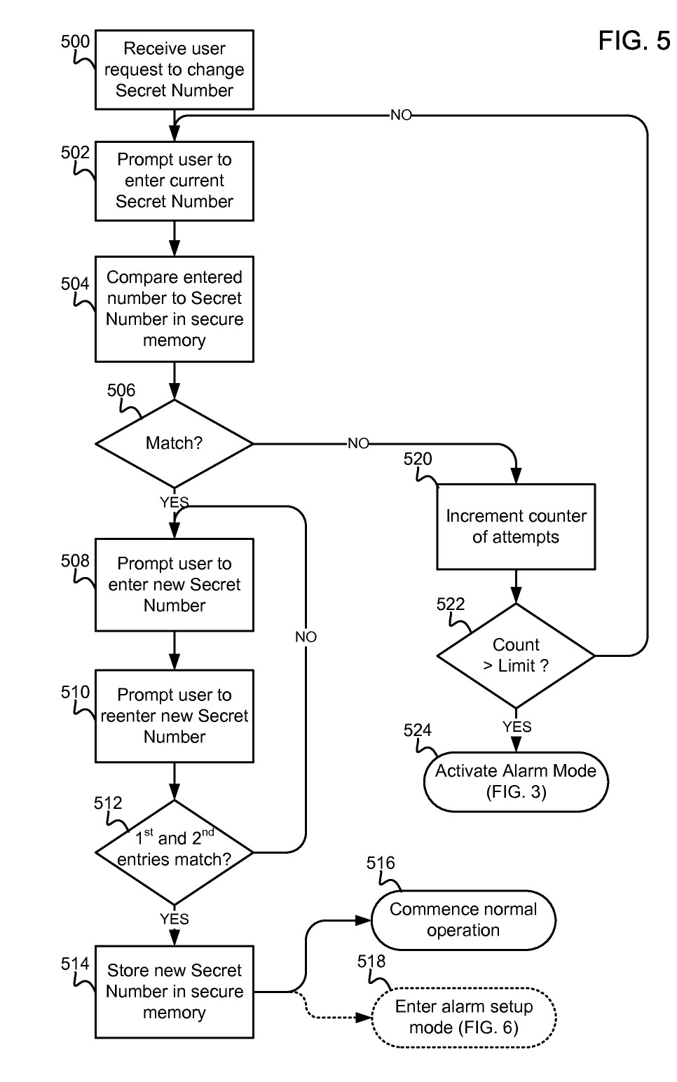

In an embodiment illustrated in FIG. 5, the user may be allowed to change the secret number of a mobile device. This may be useful when, for example, a user sells a mobile device and the new owner desires to create a memorable and personalized secret number or the previous owner desires to keep his/her secret number. An authorized user may initiate a change of the secret number by accessing a menu option in the graphical user interface of the mobile device. When the mobile device receives the user's request to change the secret number, step 500, it may prompt the user to enter the current (soon to be old) secret number, step 502. The processor may compare the secret number that is entered by the user to the secret number that is stored in the secure memory, step 504, to determine whether the two numbers match, determination 506. This ensures that only authorized users who know the current secret number can change the secret number. If the processor determine that the secret number entered by the user matches the current secret number stored in the secure memory (i.e., determination 506=“YES”), the processor may prompt the user to enter a new secret number, step 508. Once the user enters a new secret number, the processor may prompt the user to enter the new secret number again, step 510. The processor may then determine whether the two entries match, determination 512. If both entries match (i.e., determination 512=“YES”), the processor erases the current secret number and stores the new secret number in the secure memory, step 514. However, if the processor determines that the two numbers entered do not match (i.e., determination 512=“NO”), the processor may prompt the user to reenter the new secret number again, returning to step 508. This process ensures that a correct secret number is registered and stored by the mobile device. Once the new secret number has been stored in secure memory, step 514, or, optionally, enter an alarm setup mode to allow the user to configure actions that the mobile device should execute when the alarm mode is activated, optional step 518. Operations associated with the optional alarm setup mode are described below with reference to FIG. 6.

If the processor determines that the secret number entered by the user does not match the current secret number stored in the secure memory (i.e., determination 506=“NO”), the processor may increment a counter of secret number entry attempts, step 520. The processor may then determine whether the count of entry attempts exceeds a limit, determination 522. If the count of entry attempts does not exceed the limit (i.e., determination 522=“NO”), the processor may prompt the user to re-enter the current secret number, returning to step 502. However, if the processor determines that the count of entry attempts exceed the limit (i.e., determination 522=“YES”), the processor may activate the alarm mode, step 524, as described above with reference to FIG. 3. Activating the alarm mode after a limited number of incorrect entries will ensure that unauthorized users cannot defeat the alarm by attempting to guess the secret number to change it before the owner discovers it is missing and sends the alarm activation message.

As mentioned above, the alarm mode may implement a variety of functions in place of or in addition to sounding an audible alarm. Default alarm mode settings may be pre-programmed by the manufacturer or the service provider before the mobile device is sold to the end user. Alternatively, alarm mode settings may be disabled and the initial programming of the alarm mode may be the responsibility of the user. In an embodiment, the alarm mode may implement a default set of functions (e.g., sounding an audible alarm) which may be modified by a user. In an embodiment, the mobile device may be configured to provide the user with a menu or alarm setup mode for setting the alarm mode functions. In order to ensure only an authorized user of the mobile device can set or modify the alarm mode settings, the mobile device may be configured so that the alarm setup mode may be accessed only after the user has correctly entered the secret number. For example, the alarm setup mode may be activated during the initial setup of the mobile device when the secret number is first created as described above with reference to optional step 114 in FIG. 1. As another example, the alarm setup mode may be activated after the user has successfully entered the secret number at a later time to establish authority to modify alarm settings, such as to change the secret number as described above with reference to optional step 518 in FIG. 5.

When the alarm setup mode is activate, step 600, the mobile device may display a menu or similar display prompting the user to confirm that the user wants to configure or make changes to the alarm mode function settings, step 602. Upon receiving the user's response, the mobile device may determine whether the user has indicated that configuration changes are to be made, determination 604. If the user input indicates that no changes to the alarm mode functions are desired (i.e., determination 604=“No”), the alarm mode may terminate and processing of the mobile device returned to normal operations, step 606. If the user input indicates that changes to the alarm mode functions are desired (i.e., determination 604=“Yes”), a menu or similar display may be presented prompting the user to select an appropriate menu or interface for doing so, such as selecting whether alarm functions are to be configured or files are to be indicated for deletion, step 608. These two menu choices are used for illustrative purposes only, as a user interface may be configured in a wide variety of structures and option trees.

If a user response indicates a desire to configure alarm mode functions (i.e., determination 608=“Functions”), the mobile device may display a user interface or menu identifying the various functions that may be configured to activate in the alarm mode. The mobile device may receive user inputs regarding functions to be implemented in the alarm mode, step 614, and store those user configurations in an alarm mode configuration data file in secure memory, step 618. A wide variety of functions may be configurable for the alarm mode as may be useful when the mobile device is lost or stolen. For example, one function that could be user configured may be whether an audible alarm should sound and, if so, the ringtone of audio file that should be used to generate the audible alarm. Some illustrative examples of such alarm mode functionality include but are not limited to: alarm tone (e.g., in the form of a ringtone selection); alarm volume; alarm duration; alarm status (on or off status); number of times a secret number may be entered to deactivate the alarm mode; dialing “911”; causing an electric shock to a user; automatically sending messages (e.g., SMS or e-mail messages) containing position coordinates using a GPS system to a predetermined message address; deactivating selected functions (e.g., making or receiving telephone calls; accessing memory; copying memory, etc.); deactivating all functions except the alarm mode; and deleting files. For example, if a user configures the mobile device to dial “911” in the alarm mode, the mobile device will automatically place an emergency call which will relay the location of the mobile device to authorities when the alarm mode is activated. As another example, if a user configures the mobile device to automatically sending messages (e.g., SMS or e-mail messages) containing position coordinates using a GPS system to a predetermined message address, the mobile device may inform the user or authorities of the location of the mobile device so the location of an unauthorized user may be ascertained and the thief may be easily chased and apprehended. When user alarm mode functionality selections are complete, the mobile device may prompt the user for further selections, such as by returning to step 602 to ask whether further changes to the alarm mode configuration are desired.

One particular useful alarm mode function may be the automatic deletion of certain files, such as a user's personal data files. By configuring the mobile device to delete selected files when the alarm mode activates, users can ensure that their personal and valuable information stored on the mobile device cannot be accessed or copied by anyone who finds or misappropriates the mobile device. In such an embodiment, if a user response indicates a desire to configure alarm mode functions (i.e., determination 608=“Files”), the mobile device may display a user interface or menu listing data files and/or folders stored in memory, step 620. A user interface function may be provided to receive user file or folder designations, step 622. For example, a user interface may accept user button presses or screen presses (in the case of a touchscreen user interface) to select files individually, highlight selected files, and prompt the user to confirm a desire to designated the selected files for deletion when the alarm mode is activated.

In order to reduce the amount of information that must be stored in secure memory, in an alternative embodiment a user interface may accept user indications of selected file folders, types of files or portions of memory to be erased instead of individual file designations. Typical mobile device user interfaces organize memory files into folders corresponding to like files or files associated with a common element. In this embodiment, this organization of memory files can be used to enable the user to select many files by indicating folders for deletion. Using this embodiment, for example, a user could designate the user's contact list or address for deletion. As a further example, users may designate for deletion folders containing the user's personal information, such as photograph files, calendar or appointment files, notes and documents. By designating folders for deletion, many files can be designated for deletion with one folder designation.

In a further embodiment, the mobile device may be configured to store file types designated for deletion, such as all photograph files (e.g., those with a “.jpg” file extensions), all address records, and all document files (e.g., those with “.txt” or “.doc” file extensions). This embodiment would permit users to designate content specific memory area for deletion by the alarm mode. In this embodiment users may designate for deletion file types such as, for example, all contacts (e.g., all contacts, phone numbers, addresses, business cards, etc. as may be used by an address database), all media files (e.g., all images, videos, recorded voice calls, etc.), all messages (e.g., all SMS or MMS messages stored in the Inbox, Outbox, and Draft directories), business meetings notifications, reminders, calendared events, notes etc.

In a further embodiment, the mobile device may be configured to enable users to designate files for deletion according to a combination of individual files, folders and/or file types. While this would require greater memory usage, this embodiment may provide users with greater flexibility in designating files to be deleted.

The user designations files, folders and/or file types for deletion may be stored in an alarm mode configuration data file in secure memory, step 624. When user file selections are complete, the mobile device may prompt the user for further selections, such as by returning to step 602 to ask whether further changes to the alarm mode configuration are desired. Once the user indicates that no more alarm mode configuration changes are desired (i.e., determination 604=“No”), the mobile device may return to normal operation, step 606.

In a further embodiment (not shown), the alarm mode may be programmed to activate different types of alarms or ringtones when different secret numbers are received by the mobile device. For example, receipt of one secret number may direct the mobile device to sound a loud alarm, while receipt of another secret number may direct the mobile device to lock the mobile device or make automatic calls to predetermined numbers such as emergency or local police numbers. Similarly, the mobile device may be configured to receive the various secret numbers separately in different SMS messages, or receive all of activated secret numbers in the same SMS message. If different secret numbers are sent via the same SMS message, the mobile device processor may be configured to parses through the SMS message payload to identify each different secret number and direct the alarm mode to cause the response corresponding to each received secret number (e.g. sound and alarm, disable the phone, call “911”). The process steps involved in activating various alarms based upon different received secret numbers is the same as that described above with reference to FIG. 2 with the addition that in step 212 the alarm mode corresponding to the matched secret number is activated.

In an embodiment (not shown), alarm mode configuration settings may be programmed by a user through the Internet such as by accessing a secured website. For example, by entering a username and password, the user may be able to access and change the alarm mode settings remotely and without having to have access to the mobile device itself In such an embodiment, the alarm mode configuration settings may be transmitted to the mobile device from a cellular service provider in the form of an over-the-air update, for example.

In a further embodiment, the secret number may be sent in encrypted form in messages to a mobile device to further ensure the secret number is not revealed to an unauthorized user. Any known encryption method may be used to encrypt the secret number at the sending device and decrypt the received message at the receiving mobile device. In this embodiment, the steps of receiving a message (200 and 400) and/or parsing the received message (202 and 402) described above with reference to FIGS. 2 and 4 may include the process of decrypting the message or the message payload to obtain the included secret number.

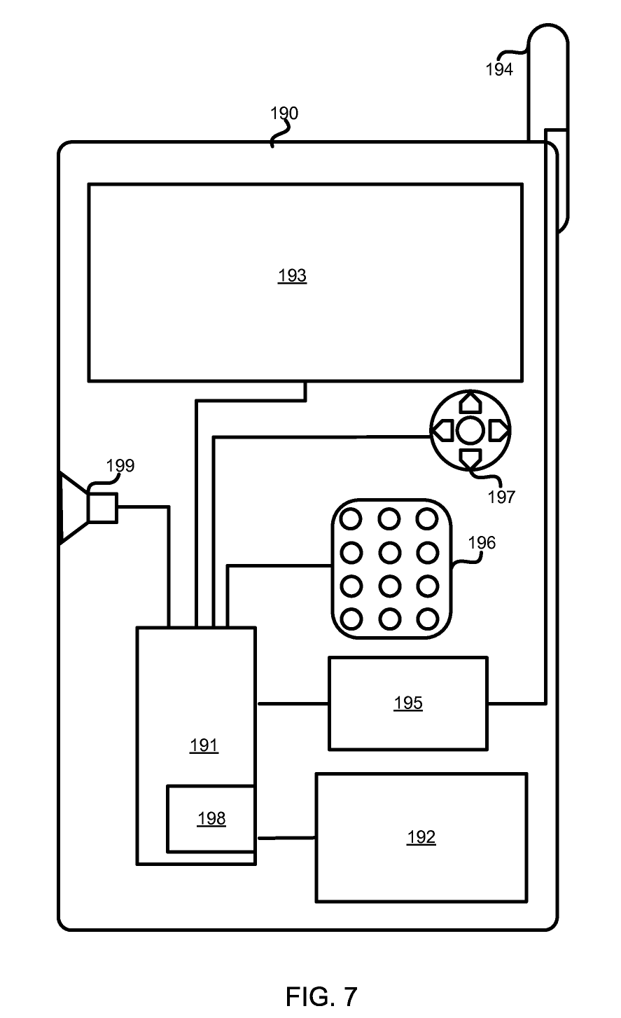

Typical mobile devices suitable for use with the various embodiments will have in common the components illustrated in FIG. 7. For example, an exemplary mobile device 190 may include a processor 191 coupled to internal memory 192, a display 193, and to a speaker 199. Additionally, the mobile device 190 may have an antenna 194 for sending and receiving electromagnetic radiation that is connected to a wireless data link and/or cellular telephone transceiver 195 coupled to the processor 191. In some implementations, the transceiver 195 and portions of the processor 191 and memory 192 used for cellular telephone communications are collectively referred to as the air interface since it provides a data interface via a wireless data link. Mobile devices typically also include a key pad 196 or miniature keyboard and menu selection buttons or rocker switches 197 for receiving user inputs.

The processor 191 may be any programmable microprocessor, microcomputer or multiple processor chip or chips that can be configured by software instructions (applications) to perform a variety of functions, including the functions of the various embodiments described herein. In some mobile devices, multiple processors 191 may be provided, such as one processor dedicated to wireless communication functions and one processor dedicated to running other applications. Typically, software applications may be stored in the internal memory 192 before they are accessed and loaded into the processor 191. In some mobile devices, the processor 191 may include internal memory sufficient to store the application software instructions. The internal memory of the processor may include a secure memory 198 which is not directly accessible by users or applications and that is capable of recording the secret number or secret numbers as described in the various embodiments. As part of the processor, such a secure memory 198 may not be replaced or accessed without damaging or replacing the processor. In some mobile devices, the secure memory may be in a separate memory chip coupled to the processor 191. In many mobile devices, the internal memory 192 may be a volatile or nonvolatile memory, such as flash memory, or a mixture of both. For the purposes of this description, a general reference to memory refers to all memory accessible by the processor 191, including internal memory 192, the secure memory 198, removable memory plugged into the mobile device, and memory within the processor 191 itself.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof If implemented in software, the functions may be stored on or transmitted over as one or more instructions or code on a computer-readable medium. The steps of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for sounding an alarm on a mobile device, comprising:
receiving a first message;
parsing the first message to receive a first number included within part of the first message;
comparing the received first number to a secret number stored in secure memory of the mobile device; and
activating an alarm mode when the received first number matches the stored secret number.

2. The method of claim 1, wherein activating the alarm mode comprises:
activating a ringtone designated for the alarm mode.

3. The method of claim 2, wherein activating the alarm mode further comprises:
activating another function in addition to activating the designated alarm mode ringtone.

4. The method of claim 1, further comprising:
generating a display prompting a user to enter the secret number;
receiving entry of an entered number;
comparing the entered number to the secret number stored in secure memory of the mobile device; and
deactivating the alarm mode when the entered number matches the stored secret number.

5. The method of claim 4, further comprising:
incrementing a counter of incorrect entries when the entered number does not match the secret number stored in secure memory; and
locking at least a portion of the mobile device functionality if the counter of incorrect entries exceeds a limit.

6. The method of claim 1, further comprising:
receiving a second message;
parsing the second message to receive a second number included within part of the second message;
comparing the received second number to the secret number stored in secure memory of the mobile device; and
deactivating the alarm mode when the received second number matches the stored secret number.

7. The method of claim 6, further comprising:
incrementing a counter of incorrect second number messages when the received second number does not match the secret number stored in secure memory; and
locking at least a portion of the mobile device functionality if the counter of incorrect second number messages exceeds a limit.

8. The method of claim 1, further comprising:
determining if a secret number is stored in the secure memory;
prompting the user to enter a secret number if there is no secret number stored in the secure memory; and
storing the entered secret number in the secure memory.

9. The method of claim 1, further comprising:
determining if the secret number stored in the secure memory equals a default value;
prompting the user to enter a secret number if the secret number stored in the secure memory equals a default value; and
storing the entered secret number in the secure memory.

10. The method of claim 1, wherein the message is a simple message service (SMS) message.

11. The method of claim 1, wherein the message is a multimedia message service (MMS) message.

12. The method of claim 1, wherein the message is an electronic mail message.

13. The method of claim 1, further comprising:
receiving a request to change the secret number;
generating a display prompting the user to enter the secret number;
comparing the entered secret number to the secret number stored in the secure memory;
prompting the user to enter a new secret number if the entered secret number matches the secret number stored in the secure memory; and
storing the entered new secret number in the secure memory.

14. The method of claim 1, further comprising:
generating a display prompting the user to enter the secret number;
comparing the entered secret number to the secret number stored in the secure memory;
generating a display to enable the user to enter alarm mode configuration selections if the entered secret number matches the secret number stored in the secure memory;
receiving user alarm mode configuration selections; and
storing the entered alarm mode configuration selections in the secure memory,
wherein activating the alarm mode further comprises activating the alarm mode configuration selections stored in the secure memory.

15. The method of claim 8, further comprising:
generating a display to enable the user to enter alarm mode configuration selections if the entered secret number matches the secret number stored in the secure memory;
receiving user alarm mode configuration selections; and
storing the entered alarm mode configuration selections in the secure memory,
wherein activating the alarm mode further comprises activating the alarm mode configuration selections stored in the secure memory.

16. The method of claim 13, further comprising:
generating a display to enable the user to change alarm mode configuration selections if the entered secret number matches the secret number stored in the secure memory;
receiving user alarm mode configuration selections; and
storing the entered alarm mode configuration selections in the secure memory,
wherein activating the alarm mode further comprises activating the alarm mode configuration selections stored in the secure memory.

17. A mobile device, comprising:
a processor;
a display coupled to the processor;
a secure memory coupled to the processor; and
a speaker coupled to the processor,
wherein the processor is configured with software instructions to perform steps comprising:
receiving a first message;
parsing the first message to receive a first number included within part of the first message;
comparing the received first number to a secret number stored in the secure memory of the mobile device; and
activating an alarm mode when the received first number matches the stored secret number.

18. The mobile device of claim 17, wherein the processor is configured with software instructions to perform steps further comprising:
generating a sound via the speaker using a ringtone designated for the alarm mode.

19. The mobile device of claim 18, wherein the processor is configured with software instructions to perform steps further comprising:
activating another function in addition to activating the designated alarm mode ringtone.

20. The mobile device of claim 17, wherein the processor is configured with software instructions to perform steps further comprising:
generating a prompt on the display prompting a user to enter the secret number;
receiving entry of an entered number;
comparing the entered number to the secret number stored in the secure memory of the mobile device; and
deactivating the alarm mode when the entered number matches the stored secret number.

21. The mobile device of claim 20, wherein the processor is configured with software instructions to perform steps further comprising:
incrementing a counter of incorrect entries when the entered number does not match the secret number stored in the secure memory; and
locking at least a portion of the mobile device functionality if the counter of incorrect entries exceeds a limit.

22. The mobile device of claim 17, wherein the processor is configured with software instructions to perform steps further comprising:
receiving a second message;
parsing the second message to receive a second number included within part of the second message;
comparing the received second number to the secret number stored in the secure memory of the mobile device; and
deactivating the alarm mode when the received second number matches the stored secret number.

23. The mobile device of claim 22, wherein the processor is configured with software instructions to perform steps further comprising:
incrementing a counter of incorrect second number messages when the received second number does not match the secret number stored in the secure memory; and
locking at least a portion of the mobile device functionality if the counter of incorrect second number messages exceeds a limit.

24. The mobile device of claim 17, wherein the processor is configured with software instructions to perform steps further comprising:
determining if a secret number is stored in the secure memory;
prompting the user to enter a secret number if there is no secret number stored in the secure memory; and
storing the entered secret number in the secure memory.

25. The mobile device of claim 17, wherein the processor is configured with software instructions to perform steps further comprising:
determining if the secret number stored in the secure memory equals a default value;
prompting the user to enter a secret number if the secret number stored in the secure memory equals a default value; and
storing the entered secret number in the secure memory.

26. The mobile device of claim 17, wherein the processor is configured with software instructions to perform steps such that the message is a simple message service (SMS) message.

27. The mobile device of claim 17, wherein the processor is configured with software instructions to perform steps such that the message is a multimedia message service (MMS) message.

28. The mobile device of claim 17, wherein the processor is configured with software instructions to perform steps such that the message is an electronic mail message.

29. The mobile device of claim 17, wherein the processor is configured with software instructions to perform steps further comprising:
receiving a request to change the secret number;
generating a prompt on the display prompting the user to enter the secret number;
comparing the entered secret number to the secret number stored in the secure memory;
generating a prompt on the display prompting the user to enter a new secret number if the entered secret number matches the secret number stored in the secure memory; and
storing the entered new secret number in the secure memory.

30. The mobile device of claim 17, wherein the processor is configured with software instructions to perform steps further comprising:
generating a display prompting the user to enter the secret number;
comparing the entered secret number to the secret number stored in the secure memory;
generating a display to enable the user to enter alarm mode configuration selections if the entered secret number matches the secret number stored in the secure memory;
receiving user alarm mode configuration selections; and
storing the entered alarm mode configuration selections in the secure memory,
wherein activating the alarm mode further comprises activating the alarm mode configuration selections stored in the secure memory.

31. The mobile device of claim 24, wherein the processor is configured with software instructions to perform steps further comprising:
generating a display to enable the user to enter alarm mode configuration selections if the entered secret number matches the secret number stored in the secure memory;
receiving user alarm mode configuration selections; and
storing the entered alarm mode configuration selections in the secure memory,
wherein activating the alarm mode further comprises activating the alarm mode configuration selections stored in the secure memory.

32. The mobile device of claim 29, wherein the processor is configured with software instructions to perform steps further comprising:
generating a display to enable the user to change alarm mode configuration selections if the entered secret number matches the secret number stored in the secure memory;
receiving user alarm mode configuration selections; and
storing the entered alarm mode configuration selections in the secure memory,
wherein activating the alarm mode further comprises activating the alarm mode configuration selections stored in the secure memory.

33. A tangible storage medium having stored thereon processor-executable software instructions configured to cause a processor to perform steps comprising:
receiving a first message;
parsing the first message to receive a first number included within part of the first message;
comparing the received first number to a secret number stored in secure memory of the mobile device; and
activating an alarm mode when the received first number matches the stored secret number.

34. The tangible storage medium of claim 33, wherein the tangible storage medium has processor-executable software instructions configured to cause a processor to perform further steps comprising:
activating a ringtone designated for the alarm mode.

35. The tangible storage medium of claim 34, wherein the tangible storage medium has processor-executable software instructions configured to cause a processor to perform further steps comprising:
activating another function in addition to activating the designated alarm mode ringtone.

36. The tangible storage medium of claim 33, wherein the tangible storage medium has processor-executable software instructions configured to cause a processor to perform further steps comprising:
generating a display prompting a user to enter the secret number;
receiving entry of an entered number;
comparing the entered number to the secret number stored in secure memory of the mobile device; and
deactivating the alarm mode when the entered number matches the stored secret number.

37. The tangible storage medium of claim 36, wherein the tangible storage medium has processor-executable software instructions configured to cause a processor to perform further steps comprising:
incrementing a counter of incorrect entries when the entered number does not match the secret number stored in secure memory; and
locking at least a portion of the mobile device functionality if the counter of incorrect entries exceeds a limit.

38. The tangible storage medium of claim 33, wherein the tangible storage medium has processor-executable software instructions configured to cause a processor to perform further steps comprising:
receiving a second message;
parsing the second message to receive a second number included within part of the second message;
comparing the received second number to the secret number stored in secure memory of the mobile device; and
deactivating the alarm mode when the received second number matches the stored secret number.

39. The tangible storage medium of claim 38, wherein the tangible storage medium has processor-executable software instructions configured to cause a processor to perform further steps comprising:
incrementing a counter of incorrect second number messages when the received second number does not match the secret number stored in secure memory; and
locking at least a portion of the mobile device functionality if the counter of incorrect second number messages exceeds a limit.

40. The tangible storage medium of claim 33, wherein the tangible storage medium has processor-executable software instructions configured to cause a processor to perform further steps comprising:
determining if a secret number is stored in the secure memory;
prompting the user to enter a secret number if there is no secret number stored in the secure memory; and
storing the entered secret number in the secure memory.

41. The tangible storage medium of claim 33, wherein the tangible storage medium has processor-executable software instructions configured to cause a processor to perform further steps comprising:
determining if the secret number stored in the secure memory equals a default value;
prompting the user to enter a secret number if the secret number stored in the secure memory equals a default value; and
storing the entered secret number in the secure memory.

42. The tangible storage medium of claim 33, wherein the message is a simple message service (SMS) message.

43. The tangible storage medium of claim 33, wherein the message is a multimedia message service (MMS) message.

44. The tangible storage medium of claim 33, wherein the message is an electronic mail message.

45. The tangible storage medium of claim 33, wherein the tangible storage medium has processor-executable software instructions configured to cause a processor to perform further steps comprising:
receiving a request to change the secret number;
generating a display prompting the user to enter the secret number;
comparing the entered secret number to the secret number stored in the secure memory;
prompting the user to enter a new secret number if the entered secret number matches the secret number stored in the secure memory; and
storing the entered new secret number in the secure memory.

46. The tangible storage medium of claim 33, wherein the tangible storage medium has processor-executable software instructions configured to cause a processor to perform further steps comprising:
generating a display prompting the user to enter the secret number;
comparing the entered secret number to the secret number stored in the secure memory;
generating a display to enable the user to enter alarm mode configuration selections if the entered secret number matches the secret number stored in the secure memory;
receiving user alarm mode configuration selections; and
storing the entered alarm mode configuration selections in the secure memory,
wherein activating the alarm mode further comprises activating the alarm mode configuration selections stored in the secure memory.

47. The tangible storage medium of claim 49, wherein the tangible storage medium has processor-executable software instructions configured to cause a processor to perform further steps comprising:
generating a display to enable the user to enter alarm mode configuration selections if the entered secret number matches the secret number stored in the secure memory;
receiving user alarm mode configuration selections; and
storing the entered alarm mode configuration selections in the secure memory,
wherein activating the alarm mode further comprises activating the alarm mode configuration selections stored in the secure memory.

48. The tangible storage medium of claim 45, wherein the tangible storage medium has processor-executable software instructions configured to cause a processor to perform further steps comprising:
generating a display to enable the user to change alarm mode configuration selections if the entered secret number matches the secret number stored in the secure memory;
receiving user alarm mode configuration selections; and
storing the entered alarm mode configuration selections in the secure memory,
wherein activating the alarm mode further comprises activating the alarm mode configuration selections stored in the secure memory.

49. A mobile device, comprising:
means for receiving a first message;
means for parsing the first message to receive a first number included within part of the first message;
means for comparing the received first number to a secret number stored in secure memory of the mobile device; and
means for activating an alarm mode when the received first number matches the stored secret number.

50. The mobile device of claim 49, wherein means for activating the alarm mode comprises:
means for activating a ringtone designated for the alarm mode.

51. The mobile device of claim 41, wherein means for activating the alarm mode further comprises:
means for activating another function in addition to activating the designated alarm mode ringtone.

52. The mobile device of claim 49, further comprising:
means for generating a display prompting a user to enter the secret number;
means for receiving entry of an entered number;
means for comparing the entered number to the secret number stored in secure memory of the mobile device; and
means for deactivating the alarm mode when the entered number matches the stored secret number.

53. The mobile device of claim 50, further comprising:
means for incrementing a counter of incorrect entries when the entered number does not match the secret number stored in secure memory; and
means for locking at least a portion of the mobile device functionality if the counter of incorrect entries exceeds a limit.

54. The mobile device of claim 49, further comprising:
means for receiving a second message;
means for parsing the second message to receive a second number included within part of the second message;
means for comparing the received second number to the secret number stored in secure memory of the mobile device; and
means for deactivating the alarm mode when the received second number matches the stored secret number.

55. The mobile device of claim 45, further comprising:
means for incrementing a counter of incorrect second number messages when the received second number does not match the secret number stored in secure memory; and
means for locking at least a portion of the mobile device functionality if the counter of incorrect second number messages exceeds a limit.

56. The mobile device of claim 49, further comprising:
means for determining if a secret number is stored in the secure memory;
means for prompting the user to enter a secret number if there is no secret number stored in the secure memory; and
means for storing the entered secret number in the secure memory.

57. The mobile device of claim 49, further comprising:
means for determining if the secret number stored in the secure memory equals a default value;
means for prompting the user to enter a secret number if the secret number stored in the secure memory equals a default value; and
means for storing the entered secret number in the secure memory.

58. The mobile device of claim 49, wherein:
means for receiving a first message comprises means for receiving a first simple message service (SMS) message; and
means for parsing the first message to receive a first number included within part of the first message comprises means for parsing a first SMS message to receive a first number included within part of the first SMS message.

59. The mobile device of claim 49, wherein:
means for receiving a first message comprises means for receiving a first multimedia message service (MMS) message; and
means for parsing the first message to receive a first number included within part of the first message comprises means for parsing a first MMS message to receive a first number included within part of the first MMS message.

60. The mobile device of claim 49, wherein:
means for receiving a first message comprises means for receiving a first electronic mail message; and
means for parsing the first message to receive a first number included within part of the first message comprises means for parsing a first electronic mail message to receive a first number included within part of the first electronic mail message.

61. The mobile device of claim 49, further comprising:
means for receiving a request to change the secret number;
means for generating a display prompting the user to enter the secret number;
means for comparing the entered secret number to the secret number stored in the secure memory;
means for prompting the user to enter a new secret number if the entered secret number matches the secret number stored in the secure memory; and
means for storing the entered new secret number in the secure memory.

62. The mobile device of claim 49, further comprising:
means for generating a display prompting the user to enter the secret number;
means for comparing the entered secret number to the secret number stored in the secure memory;
means for generating a display to enable the user to enter alarm mode configuration selections if the entered secret number matches the secret number stored in the secure memory;
means for receiving user alarm mode configuration selections; and
means for storing the entered alarm mode configuration selections in the secure memory,
wherein means for activating the alarm mode comprises means for activating the alarm mode configuration selections stored in the secure memory.

63. The mobile device of claim 56, further comprising:
means for generating a display to enable the user to enter alarm mode configuration selections if the entered secret number matches the secret number stored in the secure memory;
means for receiving user alarm mode configuration selections; and
means for storing the entered alarm mode configuration selections in the secure memory,
wherein means for activating the alarm mode comprises means for activating the alarm mode configuration selections stored in the secure memory.

64. The mobile device of claim 61, further comprising:
means for generating a display to enable the user to change alarm mode configuration selections if the entered secret number matches the secret number stored in the secure memory;
means for receiving user alarm mode configuration selections; and
means for storing the entered alarm mode configuration selections in the secure memory,
wherein means for activating the alarm mode comprises means for activating the alarm mode configuration selections stored in the secure memory.
